(19) United States
(12) Patent Application Publication
(10) Pub. No.: US 2011/0150713 A1
(43) Pub. Date: Jun. 23, 2011

(54) Catalytic membrane for biodiesel production

(76) Inventors: Bin Wen, Horseheads, NY (US); Peng Zhang, Horseheads, NY (US)

(21) Appl. No.: 12/640,279

(22) Filed: Dec. 17, 2009

(51) Int. Cl. B01J 35/00; B01J 19/24

(52) U.S. Cl. 422/149

(57) ABSTRACT

A chamber configured to confine a chemical reaction producing liquid biodiesel fuel from a liquid reactant mixture containing oil. The chamber comprises a membrane wall having a pore size capable of allowing flow of liquid biodiesel fuel through the membrane wall and retaining unreacted oil within the chamber. The membrane wall is further layered with one or more heterogeneous coatings of solid particles operable to catalyze the chemical reaction producing liquid biodiesel fuel from the liquid reactant mixture. Most of solid particles have a dimension larger than the pore size of the membrane wall so that they do not enter and clog the pores. Optionally, there are two coatings comprising a basic catalyst for a transesterification reaction and an acidic catalyst for an esterification reaction.

### TECHNICAL FIELD

In the field of liquid reaction and separation, an apparatus for biodiesel production comprising a permeable membrane casing with a heterogeneous-catalyst coating operable to produce and purify liquid biodiesel fuel.

### BACKGROUND ART

Biodiesel fuel production involves a transesterification reaction consisting of three consecutive reversible reactions: triglyceride to diglyceride to monoglyceride yielding biodiesel and glycerol. In order to increase the conversion of the oil, biodiesel or glycerol should be removed during the reaction in order to shift the equilibrium to the product side.

Use of a permeable membrane for biodiesel fuel production in the prior art is inherently deficient because catalysts needed for such production are mixed with the reactants causing fundamental problems in collection, separation, product biodiesel fuel contamination, loss of catalysts and costs for product-biodiesel-fuel purification.

When the product biodiesel fuel is produced from the mixture within a membrane casing, prior art teaches that product permeation through the membrane can be used to partially separate the product biodiesel fuel from the reaction mixture. However, the homogeneous alkali catalyst needed for such reaction is also present in the permeate stream, which means that the product biodiesel fuel is contaminated and the catalyst must be removed from the product stream and cannot be re-used in further production.

The removal process of the catalyst in the product stream involves acid neutralization and water washing processes, which in turn generate a waste stream. The cost of the removal process adds to the cost of the biodiesel fuel production process.

### SUMMARY OF INVENTION

An apparatus that includes a chamber configured to confine a chemical reaction producing liquid biodiesel fuel from a liquid reactant mixture containing oil. The chamber comprises a membrane wall having a pore size capable of allowing flow of liquid biodiesel fuel through the membrane wall and retaining unreacted oil within the chamber. The membrane wall is further layered with one or more heterogeneous coatings of solid particles operable to catalyze the chemical reaction producing liquid biodiesel fuel from the liquid reactant mixture. Most of solid particles have a dimension larger than the pore size of the membrane wall so that they do not enter and clog the pores. The heterogeneous coating permits permeation of the liquid reactant mixture into the coating, permits a chemical reaction with the catalyst to produce biodiesel fuel, and permits flow of liquid biodiesel fuel to the membrane wall. Optionally, there are two coatings comprising a basic catalyst for a transesterification reaction and an acidic catalyst for an esterification reaction.

### TECHNICAL PROBLEM

The homogeneous liquid catalyst used in present technology for biodiesel fuel production is combined with the reactant mixture and injected into the membrane chamber. This configuration generates catalyst loss, catalyst separation requirements from the reactant stream, catalyst contamination in product biodiesel fuel permeate, purification waste streams, and costs for product-biodiesel-fuel purification.

### SOLUTION TO PROBLEM

The solution is a heterogeneous catalyst (solid catalyst) coating on the tubular membrane channel surface to catalyze the esterification and transesterification reactions in biodiesel fuel production. The biodiesel fuel then passes through the membrane wall with no catalyst contamination.

### ADVANTAGEOUS EFFECTS OF INVENTION

This invention has advantages in biodiesel fuel production in that it does not lose catalysts in the reaction, there is no catalyst separation required for the biodiesel fuel product, the biodiesel fuel product is purer, there is no waste stream from purification, and costs for biodiesel production are minimized.

### BRIEF DESCRIPTION OF DRAWINGS

The drawings show preferred embodiments of a catalytic membrane comprising the invention. New reference numbers in each drawing are given a corresponding series number beginning with the figure number.

FIG. 1 is a perspective view of a rectangular channel membrane with the top-wall catalyst coating in accordance with the invention.

FIG. 2 is a perspective view of a tubular membrane with a catalyst coating on the inside wall in accordance with the invention.

FIG. 3 is a perspective view of a hexagonal alumina membrane with multiple tubular channels each with an internal catalyst coating in accordance with the invention.

FIG. 4 is an end view of a circular tubular membrane with two coatings of differing catalysts.

FIG. 5 is a micrograph of a membrane wall with a catalyst coating.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention.

The embodiments shown in FIG. 1 through FIG. 4 represent different structural configurations of the invention comprising the same components.

In reference to FIG. 1, a preferred embodiment of the invention is an apparatus (100) comprising: a chamber (120) and a heterogeneous particle coating (110) on the top inside surface of the chamber (120).

The chamber (120) is configured to confine a chemical reaction producing liquid biodiesel fuel from a liquid reactant mixture containing oil. This configuration is preferably one in which the chamber is part system where the reaction can be confined within the chamber (120) that is subjected to a temperature and pressure suitable for conversion of oil to biodiesel fuel. This is indicated by the end component (130), which is intended to represent an end cap or connection to a larger system where the liquid reactant mixture can be introduced into the chamber (120).

The chamber (120) comprises a membrane wall having a pore size capable of allowing flow of liquid biodiesel fuel through the chamber wall and retaining unreacted oil within the chamber (120). Membranes for this purpose are commercially available, such as the hexagonal multi-channel membrane module designs similar to that shown in FIG. 3, but without the heterogeneous particle coating (110).

Suitable membrane materials include ceramics, carbon, polymer, and other commonly used materials for membranes that have the suitable properties for product separation from reactants and can operate under biofuel production conditions.

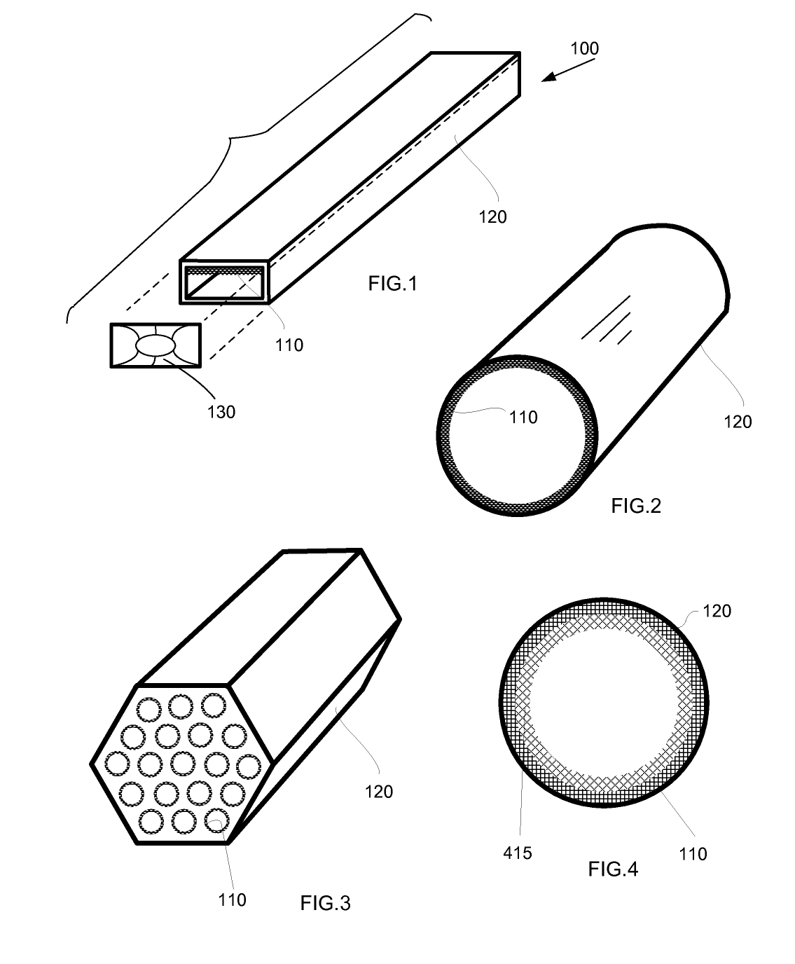

Several different preferred embodiments of the chamber and heterogeneous particle coating are shown in FIGS. 1-4. In FIG. 1, the heterogeneous particle coating (110) on the membrane wall is at the top of the chamber (120) with the rectangular cross-section. It may be on one or more of the other three walls as well. In FIG. 2, the heterogeneous particle coating (110) coats the entire inner wall surface of the chamber (120) having a circular cross section. In FIG. 3, the chamber (120) is and has a perforated monolith cross-section comprising an alumina membrane. The monolith is configured to define a plurality of tubular through-holes through the monolith, wherein the wall surrounding each hole has at least one heterogeneous particle coating (110). FIG. 4 illustrates a chamber with two heterogeneous particle coatings (110 and 415).

The membrane wall of the chamber (120) is preferably in tubular shape, as shown in FIG. 2, although other shapes are equally feasible. In certain embodiments, membrane is in the form of a monolith with a plurality of parallel inner channels defined by porous walls, as shown for a ceramic monolith in FIG. 3. Because of their high chemical and thermal stability and low cost, ceramic tubular membranes are commonly used in membrane reactors. The channels are preferably in round cross-sectional shape. The number, spacing, and arrangement of the inner channels is not critical to the operability of the invention.

The heterogeneous particle coating (110) comprises a solid catalyst operable to catalyze the chemical reaction producing liquid biodiesel fuel from the liquid reactant mixture. Such catalysts are well known in the field.

There may be a plurality of heterogeneous particle coatings comprising catalysts for differing chemical reactions. Preferably, there are two such heterogeneous particle coatings (110 and 415) comprising a basic catalyst for a transesterification reaction and an acidic catalyst for an esterification reaction.

The particles in the particle coating (110) should predominantly have a dimension larger than the pore size of the membrane to preclude the particles from entering the membrane pores, clogging them and diminishing the ability of the membrane to convey the biodiesel fuel through the wall of the chamber for collection.

The heterogeneous particle coating (110) is configured to permit permeation of the liquid reactant mixture into the coating. The reactions occur on the surface and inside the heterogeneous particle coating (110). This configuration is possible only if the coating is a porous layer. One method of creating this configuration is to apply the catalyst particles to the membrane wall by flow coating in a suitable liquid or slurry. The membrane with the catalyst particles is then dried and calcined, thus forming the porous layer. Additional porous catalyst layers can be applied to the coated membrane wall by repeating the above process, for example, with different catalyst.

The heterogeneous particle coating (110) is further configured to permit a chemical reaction with the coating producing biodiesel fuel. This configuration is possible if the particles are in direct contact with the liquid reactant mixture to catalyze the reaction. The preferred structure is a porous one where much of each particle's surface area is available for contact with the liquid reactant mixture.

The heterogeneous particle coating (110) is further configured to permit flow of liquid biodiesel fuel to the chamber wall. Once the reaction takes place in the presence of the catalyst, the biodiesel fuel must be permitted to permeate the membrane wall and exit the chamber (120). If the coating blocks the pores in the membrane wall then it would prevent operation of the invention. Thus, the coating must be formed such that it permits flow of the biodiesel fuel out of the chamber (120).

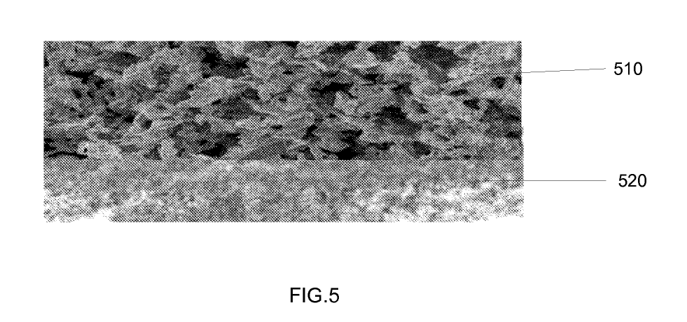

FIG. 5 is a micrograph showing a portion of the membrane wall (520) and the heterogeneous particle coating (510). It shows an irregular assembly of particles creating the necessary porosity of the heterogeneous particle coating (510).

Another example of applying the heterogeneous particle coating (110) to obtain these configurations is by employing a dip-coating-under-vacuum procedure. This involves ball-milling an aqueous slurry of the solid particle catalyst to control the particle size in the slurry. The solid content of the catalyst in the slurry and the particle size of the catalyst affect the catalyst slurry viscosity. The catalyst slurry viscosity is correlated to the catalyst coating thickness, as well as to the quality of the catalyst coating in terms of homogeneity and reproducibility. Drying and calcining then creates a very porous layer, which provides passageways for the liquid molecules to access the active sites inside the coating with minimal mass transfer limitations, significantly increasing the catalyst utilization efficiency and activity.

### Example

The best use of the invention is as a reactor consisting of a tubular membrane module, that is, an alumina chamber as shown in FIG. 3, with many small parallel straight membrane channels coated with a highly active heterogeneous catalyst on the channel surface as a catalyst layer. The chamber (120) is placed inside a stainless steel outer shell to collect the permeate product biodiesel fuel. Soybean oil (or other oil) and methanol is mixed to form a reactant mixture that is continuously fed to the chamber by a high temperature and high pressure metering pump. The transesterification reaction takes place in the pores and on the surface of the catalyst layer to produce biodiesel fuel. A positive pressure gradient is maintained between the membrane channels and shell side to drive the biodiesel/methanol/glycerol permeation through the membrane wall while the unreacted oil droplets are retained in the retentate side within the chamber (120). The unreacted oil is circulated in a loop by a circulation pump through the chamber (120). This permits a continuous production of a very pure biodiesel irrespective of reaction completion.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the energy industry.

What is claimed is:

1. An apparatus comprising:
a chamber configured to confine a chemical reaction producing liquid biodiesel fuel from a liquid reactant mixture containing oil;
wherein the chamber comprises a membrane wall having a pore size capable of allowing flow of liquid biodiesel fuel through the membrane wall and retaining unreacted oil within the chamber;
a heterogeneous particle coating on the membrane wall, the heterogeneous particle coating comprising a solid catalyst operable to catalyze the chemical reaction producing liquid biodiesel fuel from the liquid reactant mixture;
wherein most particles in the heterogeneous particle coating have a dimension larger than the pore size of the membrane wall; and,
wherein the heterogeneous particle coating is configured to permit:
permeation of the liquid reactant mixture into the coating;
a chemical reaction with the catalyst to produce biodiesel fuel; and,
flow of liquid biodiesel fuel to the membrane wall.

2. The apparatus of claim 1 comprising a plurality of heterogeneous particle coatings comprising a basic catalyst for a transesterification reaction and an acidic catalyst for an esterification reaction.
